(19) United States
(12) Patent Application Publication
(10) Pub. No.: US 2013/0159736 A1
(43) Pub. Date: Jun. 20, 2013

(54) ELECTRONIC APPARATUS WITH LOW POWER CONSUMPTION, AND CONTROL METHOD AND STORAGE MEDIUM THEREFOR

(71) Applicant: Canon Kabushiki Kaisha, Tokyo (JP)

(72) Inventor: Katsuhiko Yanagawa, Inagi-shi (JP)

(73) Assignee: CANON KABUSHIKI KAISHA, Tokyo (JP)

(21) Appl. No.: 13/709,115

(22) Filed: Dec. 10, 2012

(30) Foreign Application Priority Data
Dec. 16, 2011 (JP) 2011-275565

(51) Int. Cl. G06F 1/26

(52) U.S. Cl. CPC G06F 1/263
USPC 713/300

(57) ABSTRACT

An electronic apparatus in which an AC power source and a secondary battery are used in combination and which is capable of reducing power consumption. Among plural apparatuses that constitute an image processing apparatus serving as an electronic apparatus, part of the plural apparatuses can be supplied with power from a secondary battery. In a case where power use efficiency attained when required power for all apparatuses to be operated, among the part of the plural apparatuses, is supplied from the secondary battery is higher than conversion efficiency of an AC power unit attained when the required power is supplied from the AC power unit, FETs are controlled such that power is supplied from the secondary battery to the apparatuses to be operated.

### BACKGROUND OF THE INVENTION

1. Field of the Invention

The present invention relates to an electronic apparatus with low power consumption, and a control method and a storage medium therefor.

2. Description of the Related Art

A recent printing apparatus such as a printer or a multi-function peripheral is configured to transit to a power saving mode to reduce the power consumption upon fulfillment of a predetermined condition such as lapse of a predetermined time period from completion of a printing operation.

To further reduce the power consumption in the power saving mode, a printing apparatus has been proposed that uses the power of a secondary battery in the power saving mode (see, for example, Japanese Laid-open Patent Publication No. 2007-62243).

In the proposed printing apparatus, all the power required in the power saving mode is supplied from the secondary battery, and commercially available AC power of 100 V to 230 V is converted into low voltages of e.g. 2.5 V, 3.3V, and 12V to obtain DC power for charging the secondary battery and to obtain DC operating power for the printing apparatus.

However, the AC/DC conversion efficiency is not constant and generally decreases with decreasing power consumption, and some power loss occurs when the secondary battery is charged and when the secondary battery is discharged. Accordingly, the power that can be taken out from the secondary battery being discharged becomes smaller than the power required to charge the secondary battery.

The printing apparatus disclosed in Japanese Laid-open Patent Publication No. 2007-62243 becomes high-priced since it requires a large-capacity secondary battery capable of supplying all the power required in the power saving mode. The total amount of power consumption (including the power consumption at the time of battery charging) does not necessarily decrease since the power of the secondary battery is used irrespective of an amount of power consumption (AC/DC conversion efficiency). In addition, since all the communication functions of a network and others are always made available, power is wastefully consumed when any of the communication functions is unnecessary to be used.

### SUMMARY OF THE INVENTION

The present invention provides an electronic apparatus in which an AC power source and a secondary battery are used in combination and which is capable of reducing power consumption, and provides a control method and a storage medium for the electronic apparatus.

According to one aspect of this invention, there is provided an electronic apparatus constituted by plural apparatuses that operate when supplied with power, which comprises a conversion unit configured to convert AC power supplied from an AC power source into DC power for output, a secondary battery configured to be charged with the DC power output from the conversion unit and configured to be capable of supplying power to a part of the plural apparatuses, a switching unit configured to be capable of switchingly supplying to the part of the plural apparatuses, on a per apparatus basis, either the DC power output from the conversion unit or power from the secondary battery, and a control unit configured, in a case where conversion efficiency of the conversion unit attained when required power for all apparatuses to be operated, among the part of the plural apparatuses, is supplied from the conversion unit is higher than power use efficiency attained when the required power is supplied from the secondary battery, to control the switching unit such that the DC power output from the conversion unit is supplied to the apparatuses to be operated, and configured, in a case where the power use efficiency is higher than the conversion efficiency, to control the switching unit such that power is supplied from the secondary battery to the apparatuses to be operated.

With this invention, it is possible to reduce the power consumption in an electronic apparatus in which an AC power source and a secondary battery are used in combination.

Further features of the present invention will become apparent from the following description of an exemplary embodiment with reference to the attached drawings.

### BRIEF DESCRIPTION OF THE DRAWINGS

FIG. 1 is a view schematically showing the construction of an image processing apparatus according to one embodiment of this invention;

FIG. 2 is a view showing a relation among power consumption on a DC secondary side of an AC power unit of the image processing apparatus, power consumption on an AC primary side of the AC power unit, and AC/DC conversion efficiency of the AC power unit;

FIG. 3 is a view showing a setting screen for making a setting for performing apparatus operation state transition in response to the press of a soft switch of the image processing apparatus;

FIG. 4 is a view showing a startup time setting screen displayed when a “jump to startup time setting” button is touched on the setting screen of FIG. 3;

FIG. 5 is a view showing a setting screen displayed when a “case-by-case selection” option is selected on the setting screen of FIG. 3;

FIG. 6 is a view showing a setting screen for making a setting for performing apparatus operation state transition according to the time period elapsed after completion of operating state of the image processing apparatus;

FIG. 7 is a flowchart showing apart of procedures of a power control process executed by a power controller of the image processing apparatus;

FIG. 8 is a flowchart showing the remaining part of the procedures of the power control process; and

FIG. 9 is a flowchart showing procedures of a power control process executed by a CPU of the image processing apparatus.

### DESCRIPTION OF THE EMBODIMENTS

The present invention will now be described in detail below with reference to the drawings showing a preferred embodiment thereof.

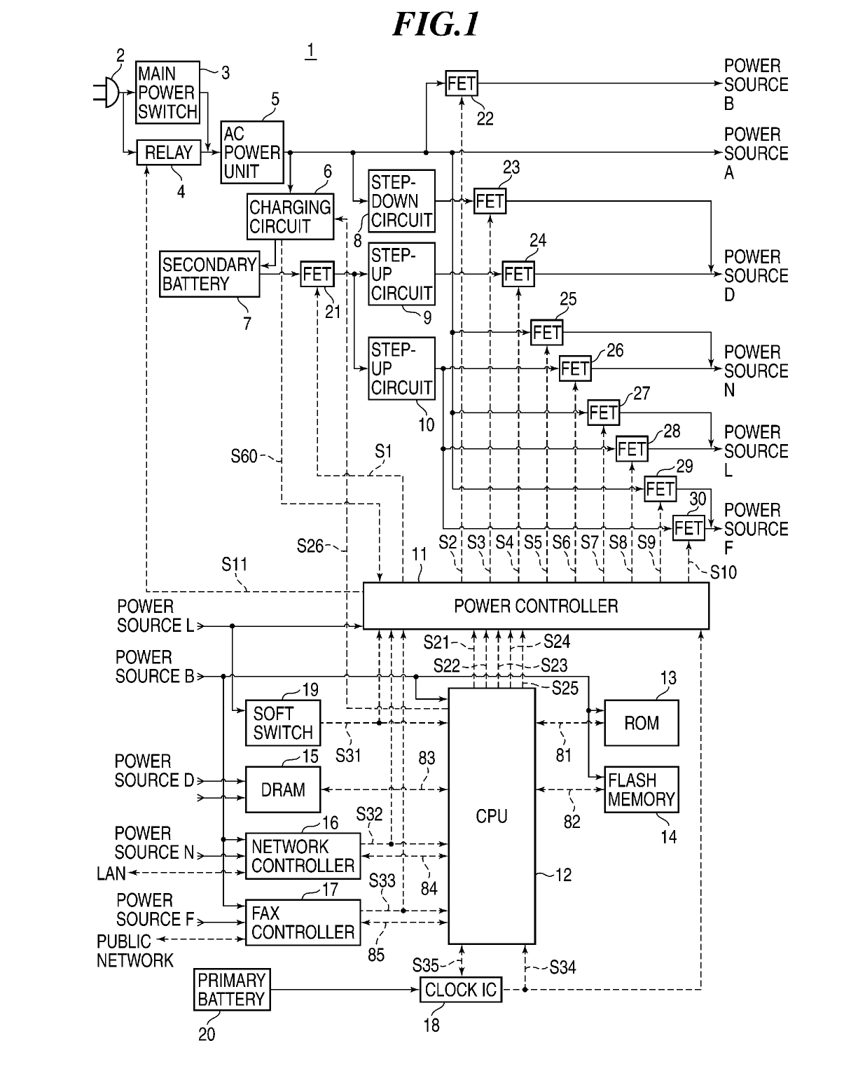

FIG. 1 schematically shows the construction of an image processing apparatus, which is an example of an electronic apparatus according to one embodiment of this invention.

In FIG. 1, reference numeral 1 denotes the image processing apparatus of this embodiment. The operation state of the image processing apparatus 1 is classified into an operating state, standby state, LAN/FAX active waiting state, FAX active waiting state, high-speed startup waiting state, timer startup waiting state, and off state.

The term “operating state” refers to a state where the apparatus is performing printing, scanning, or the like. The term “standby state” refers to a state which is not the operating state but in which the apparatus is capable of or ready for immediately performing printing, scanning, or the like. The term “LAN/FAX active waiting state” refers to a state where functions (other than a function of receiving packets directed to the apparatus from a network and other than a function of detecting an incoming FAX) are stopped, thereby reducing the power consumption. The term “FAX active waiting state” refers to a state where a network function is made off from the LAN/FAX active waiting state, thereby further reducing the power consumption. The term “high-speed startup waiting state” refers to a state where a FAX function is made off from the FAX active waiting state, thereby making a startup time period shorter than a time period for startup from the off state. The term “timer startup waiting state” refers to a state where the network function, FAX function, and high-speed startup function are made off and where automatic startup can be made at a predetermined time. The term “off state” refers to a state where all the functions are made off and no power is consumed.

As shown in FIG. 1, the image processing apparatus 1 has a plug 2 connected to a commercially available AC power source of 100 V to 230 V. An output side of the plug 2 is connected to an AC power unit 5 through a main power switch 3 and a relay 4, which are connected in parallel to each other. The main power switch 3 is a manually-operated switch, which is configured to be switched on when pressed and switched off when the press of the switch is released. A switch having a reset function of being switched off when a built-in solenoid is energized can be used instead of the manually-operated switch. The relay 4 is a latching relay whose on/off switching is electrically controlled and which does not consume power other than when switched on/off.

When the main power switch 3 is switched on to thereby turn on the relay 4, the AC power unit 5 generates DC power having a voltage of, e.g., 3.3 V from the commercially available AC power supplied through the plug 2 and the relay 4. In other words, the AC power unit 5 functions as a conversion unit that converts AC power supplied from an AC power source into DC power. However, conversion loss is caused when the AC power unit 5 generates DC power from AC power.

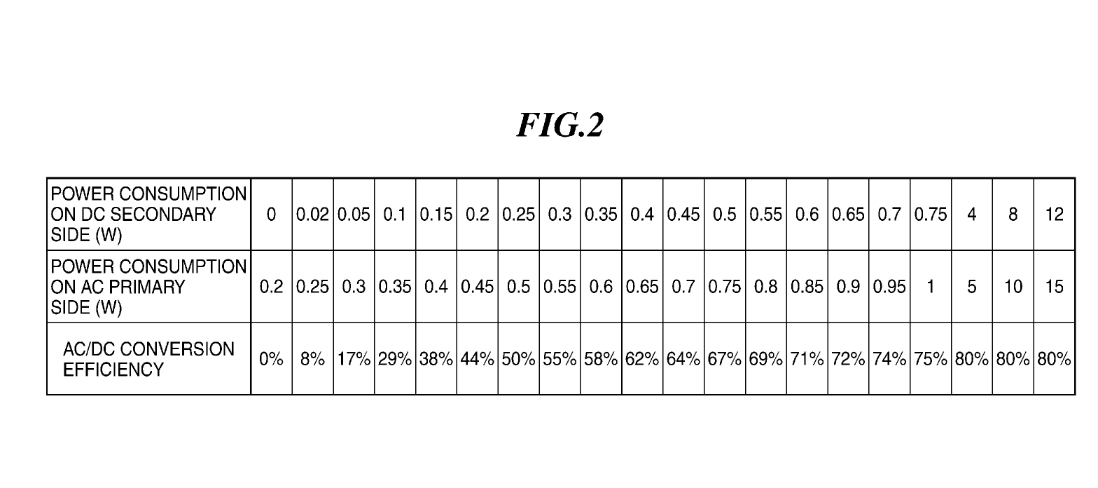

FIG. 2 shows a relation among power consumption on a DC secondary side of the AC power unit 5, power consumption on an AC primary side thereof, and AC/DC conversion efficiency of the power unit 5. Referring to FIG. 2, the AC/DC conversion efficiency is 80% when the power consumption on the DC secondary side is 4 W, and it is 50% when the power consumption on the DC secondary side is 0.25 W. Even when no power is consumed on the DC secondary side, 0.2 W power is consumed on the AC primary side when the AC power source is on.

Referring to FIG. 1 again, the image processing apparatus 1 includes a charging circuit 6 connected to the AC power unit 5 and includes a secondary battery 7 charged by the charging circuit 6.

The secondary battery 7 (which is e.g. a lithium ion battery or a nickel hydride battery) can be charged for repeated use. In such a secondary battery, some power loss generally occurs when the battery is charged and discharged, and therefore the power that can be taken out from the battery being discharged becomes smaller than the power required to charge the battery. The charge-discharge efficiency of the secondary battery 7 is e.g. 80%. In this embodiment, the secondary battery 7 is charged in a state that the AC power unit 5 is high in AC/DC conversion efficiency. When the secondary battery 7 is charged e.g. at 80% AC/DC conversion efficiency, total use efficiency of the secondary battery 7 becomes 64% (i.e., the product of AC/DC conversion efficiency of 80% and charge-discharge efficiency of 80%).

The charging circuit 6 is a constant current circuit, which is mainly constituted by transistors, resistors, etc., and in which the output power from the AC power unit 5 is used as a power source. The charging circuit 6 has a function of detecting overcharging of the secondary battery 7 and stops charging the battery 7 when detecting battery overcharging.

The image processing apparatus 1 has a voltage step-down circuit 8 that generates a 2.5 V operating voltage of the DRAM 15 from the 3.3 V output power of the AC power unit 5 (hereinafter, referred to as the power source A). A voltage step-up circuit 9 generates a 2.5 V operating voltage of the DRAM 15 from the 1.2 V output voltage of the secondary battery 7. A voltage step-up circuit 10 generates a 3.3 V operating voltage of the power controller 11, network controller 16, and FAX controller 17 from the 1.2 V output voltage of the battery 7.

A first FET 21 is disposed between the secondary battery 7 and the voltage step-up circuit 9. The AC power unit 5 is connected at its output side with input terminals of second, fifth, seventh, and ninth FETs 22, 25, 27 and 29. The second FET 22 has an output terminal connected to the CPU 12, ROM 13, flash memory 14, network controller 16, and FAX controller 17. An output terminal of the fifth FET 25 is connected to the network controller 16, an output terminal of the seventh FET 27 is connected to the power controller 11 and to the soft switch 19, and an output terminal of the ninth FET 29 is connected to the FAX controller 17.

A third FET 23 is connected between the output side of the voltage step-down circuit 8 and the DRAM 15, and a fourth FET 24 is connected between the output side of the voltage step-up circuit 9 and the DAM 15. The voltage step-up circuit 10 is connected at its output side with input terminals of sixth, eighth, and tenth FETs 26, 28 and 30. An output terminal of the sixth FET 26 is connected to the network controller 16, an output terminal of the eighth FET 28 is connected to the power controller 11 and to the soft switch 19, and an output terminal of the tenth FET 30 is connected to the FAX controller 17.

The FETs 21 to 30 are switched on and off according to control signals S1 to S10, which are respectively applied from the power controller 11 to control terminals of the FETs 21 to 30.

When the first FET 21 is switched on, the output voltage of the secondary battery 7 is supplied to the voltage step-up circuits 9 and 10. When the second FET 22 is switched on, the output power of the FET 22 (hereinafter, referred to as the power source B) corresponding to the output power of the AC power unit 5 is turned on. As a result, power is supplied from the power source B to the CPU 12, ROM 13, flash memory 14, network controller 16, and FAX controller 17. When the third or fourth FET 23 or 24 is switched on, the output power of the FET 23 or 24 (hereinafter, referred to as the power source D) corresponding to the output power of the voltage step-down circuit 8 or of the voltage step-up circuit 9 is turned on, so that power is supplied from the power source D to the DRAM 15.

When the fifth or sixth FET 25 or 26 is switched on, the output power of the FET 25 or 26 (hereinafter, referred to as the power source N) corresponding to the output power of the AC power unit 5 or of the voltage step-up circuit 10 is turned on, so that power is supplied from the power source N to the network controller 16. When the seventh or eighth FET 27 or 28 is switched on, the output power of the FET 27 or 28 (hereinafter, referred to as the power source L) corresponding to the output power of the AC power unit 5 or of the voltage step-up circuit 10 is turned on, so that power is supplied from the power source L to the power controller 11 and to the soft switch 19. When the ninth or tenth FET 29 or 30 is switched on, the output power of the FET 29 or 30 (hereinafter, referred to as the power source F) corresponding to the output power of the AC power unit 5 or of the voltage step-up circuit 10 is turned on, so that power is supplied from the power source F to the FAX controller 17.

The power controller 11 monitors a voltage signal S60 output from the charging circuit 6 and representing the output voltage of the secondary battery 7, and detects a reduction in capacity of the battery 7 where the capacity is related to the output voltage of the battery 7. Power consumption of the power controller 11 is about 0.02 W, for example.

The image processing apparatus 1 includes a primary battery 20 (e.g. a dry battery or a lithium battery) and a clock IC 18 which is supplied with power from the primary battery 20 and which remains operable even if AC power supply is disconnected. The clock IC 18 not only counts current date and time, but also has an alarm function for outputting an interrupt signal (clock alarm signal S34) upon arrival of a set time and a timer function for outputting an interrupt signal upon lapse of a set time period.

The CPU 12 of the image processing apparatus 1 is connected through busses 81 to 85 to the ROM 13, flash memory 14, DRAM 15, network controller 16, and FAX controller 17. The CPU 12 operates according to a program stored in the ROM 13 or in the DRAM 15 and controls respective parts of the image processing apparatus 1.

The CPU 12 outputs a charge control signal S26 according to which the start and stop of charging of the battery 7 by the charging circuit 6 are controlled. The CPU 12 uses an interface signal S35 to perform a setting of the clock IC 18 and to read clock information from the clock IC 18. When the time set in advance to the clock IC 18 by the CPU 12 is reached, the clock IC 18 outputs the clock alarm signal S34.

It should be noted that since the CPU 12 is relatively large in power consumption, power supply from the power source B to the CPU 12 is stopped to reduce power consumption when the image processing apparatus 1 is in the waiting state.

In the ROM 13, a startup program of the CPU 12 is stored. The flash memory 14 is an electrically rewritable nonvolatile memory, in which a control program of the image processing apparatus 1 is stored. The control program is developed on the DRAM 15 from the flash memory 14 and executed by the CPU 12. The DRAM 15 is also used to store image data and used as a work memory of the CPU 12.

The DRAM 15 uses the output power of the FET 23 or 24 (power source D) as its operating power. When the image processing apparatus 1 is in the LAN/FAX active waiting state or in the FAX active waiting state or in the high-speed startup waiting state, the DRAM 15 operates to hold data in a self-refresh mode where its power consumption is small. The power consumption of the DRAM 15 in the self-refresh mode is about 0.18 W, for example.

The network controller 16 controls communication with an external network. In the LAN/FAX active waiting state, power supply from the power source B to that part of the network controller 16 which communicates with the CPU 12 is stopped. The network controller 16 monitors the network, while being supplied with power only from the power source N. When receiving a packet directed to the image processing apparatus 1, the network controller 16 gives a notification to the power controller 11. Power consumption of the network controller 16 in the LAN/FAX active waiting state is about 0.4 W, for example.

The FAX controller 17 controls facsimile communication through the public network. In the FAX active waiting state, power supply from the power source B to that part of the FAX controller 17 which controls communication and to that part of the FAX controller 17 which communicates with the CPU 12 is stopped. The FAX controller 17 monitors the public network, while being supplied with power only from the power source F, and gives a notification to the power controller 11 when receiving an incoming FAX directed to the image processing apparatus 1. Power consumption of the network controller 16 in the FAX active waiting state is about 0.05 W, for example.

When the image processing apparatus 1 is in any of the LAN/FAX active waiting state, FAX active waiting state, high-speed startup waiting state, and timer startup waiting state, the soft switch 19 when pressed outputs a soft switch interrupt signal S31 to the power controller 11. In the standby state, the soft switch 19 when pressed outputs the soft switch interrupt signal S31 to the CPU 12. When receiving the signal S31, the CPU 12 outputs to the power controller 11 a signal that instructs transition to the waiting state or to the off state.

Symbols S21 to S25 respectively represent a first transition instruction signal that instructs transition to the LAN/FAX active waiting state, a second transition instruction signal that instructs transition to the FAX active waiting state, a third transition instruction signal that instructs transition to the high-speed startup waiting state, a fourth transition instruction signal that instructs transition to the timer startup waiting state, and a fifth transition instruction signal that instructs transition to the off state.

It is possible to set in advance whether transition should be made either to the waiting state or to the off state in response to the soft switch interrupt signal S31. Alternatively, it is possible to allow a user to select, through an operation part (not shown), transition to the waiting state or transition to the off state.

In this embodiment, transition is made either to the waiting state or to the off state according to the soft switch 19 being pressed or according to the time period elapsed after completion of operation of the image processing apparatus 1.

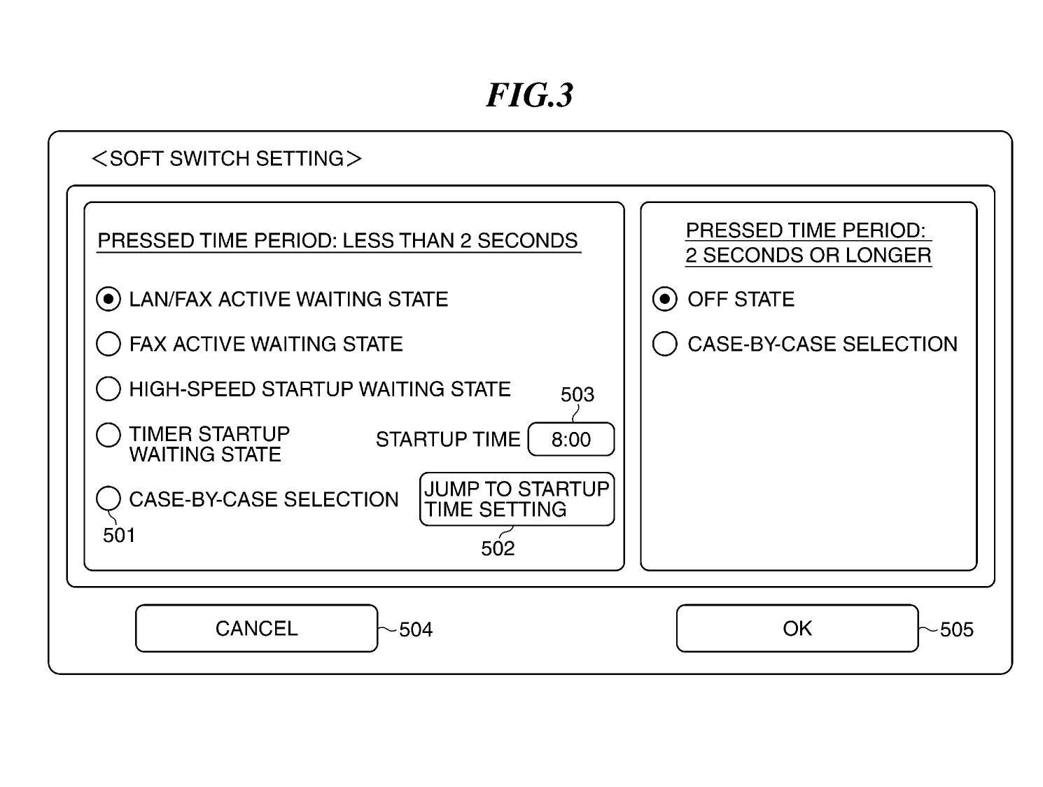

FIG. 3 shows a setting screen for making a setting of what type of apparatus operation state transition is to be made in response to the press of the soft switch 19.

On the setting screen of FIG. 3, there are performed a setting of what type of apparatus operation state transition is to be made when the soft switch 19 is pressed for less than 2 seconds, and a setting of what type of apparatus operation state transition is to be made when the soft switch 19 is pressed for 2 seconds or longer.

On the left side of the setting screen, there are displayed five radio buttons 501 respectively corresponding to a “LAN/FAX active waiting state” option, a “FAX active waiting state” option, a “high-speed startup waiting state” option, a “timer startup waiting state” option, and a “case-by-case selection” option. In the setting for a case where the soft switch is pressed for less than 2 seconds, a desired one of these options is selected by touching a corresponding one of the radio buttons 501. In the setting for a case where the soft switch is pressed for 2 seconds or longer, either the “off state” option or the “case-by-case selection” option is selected by touching a corresponding one of two radio buttons displayed on the right side of the setting screen. In the following description, the LAN/FAX active waiting state, FAX active waiting state, high-speed startup waiting state, and timer startup waiting state will sometimes be referred to as the first to fourth waiting states, respectively.

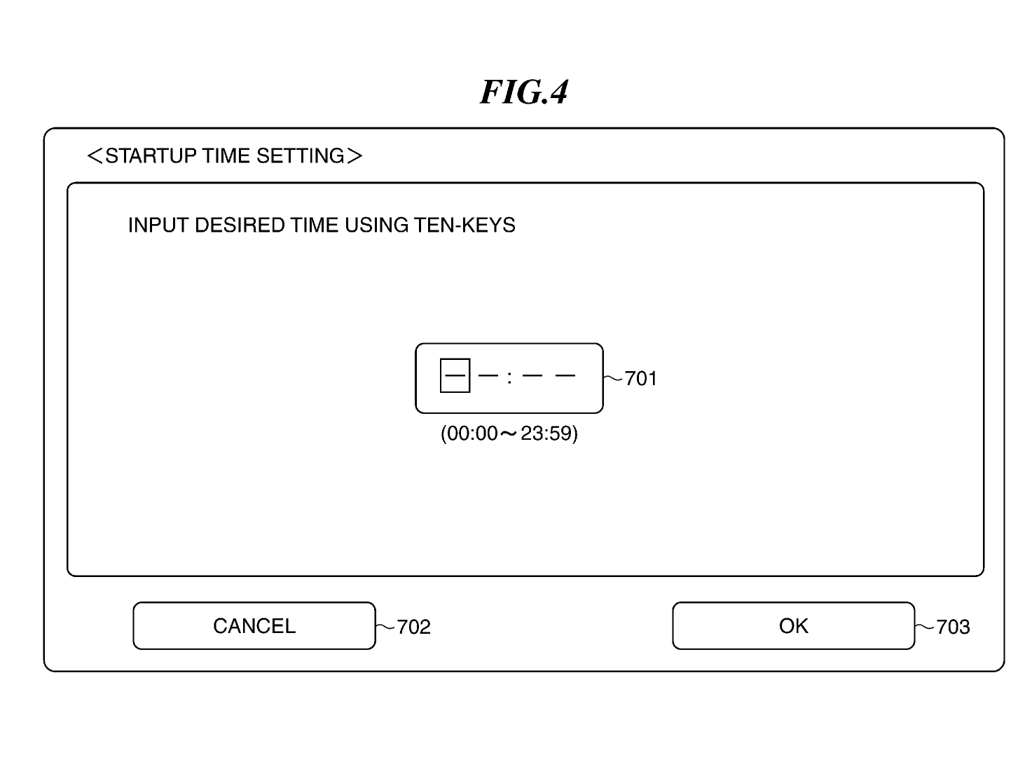

The “timer startup waiting state” option is selected to make valid a function for automatic startup at a fixed time every day. The automatic startup time can be set on a startup time setting screen of FIG. 4, which is displayed when a “jump to startup time setting” button 502 is touched on the setting screen. The startup time thus set is displayed in a startup time display area 503.

The “case-by-case selection” option is selected in a case where a transition destination (the waiting state or the off state) is to be selected each time the soft switch 19 is pressed.

When an OK button 505 is touched after one of the options is selected on the setting screen of FIG. 3, the selection is reflected to the setting. When a cancel button 504 is touched, the selection is canceled.

FIG. 4 shows the startup time setting screen displayed when the “jump to startup time setting” button 502 shown in FIG. 3 is touched.

On the startup time setting screen of FIG. 4, time varying from 00:00 to 23:59 can be input by using ten-keys (not shown) and the input time is displayed in an area 701. When an OK button 703 is touched, the input time is reflected to the setting and set as an alarm generation time in the clock IC 18 by the CPU 12. When a cancel button 702 is touched, the input time is canceled and returning to the setting screen of FIG. 3 is made.

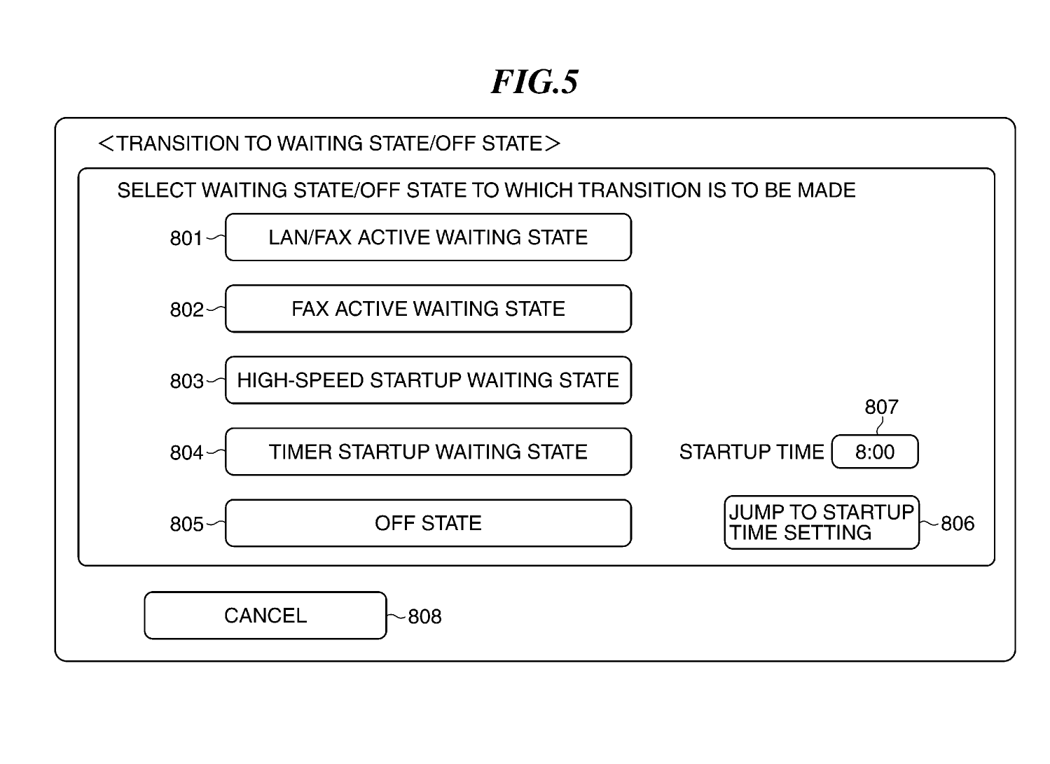

FIG. 5 shows a setting screen that is displayed when the “case-by-case selection” option is selected by touching the corresponding radio button 501 on the setting screen of FIG. 3.

On the setting screen of FIG. 5, a “LAN/FAX active waiting state” button 801, a “FAX active waiting state” button 802, a “high-speed startup waiting state” button 803, a “timer startup waiting state” button 804, and an “off state” button 805 are displayed. When any of the buttons 801 to 805 is touched, the LAN/FAX active waiting state, FAX active waiting state, high-speed startup waiting state, timer startup waiting state, or off state is selected, and the image processing apparatus 1 transits to the selected operation state. When a “jump to startup time setting” button 806 is touched after the “timer startup waiting state” button 804 is touched, the startup time setting screen of FIG. 4 is displayed and a startup time set on that screen is displayed in a startup time display field 807. When a cancel button 808 is touched, the image processing apparatus 1 is maintained in the standby state.

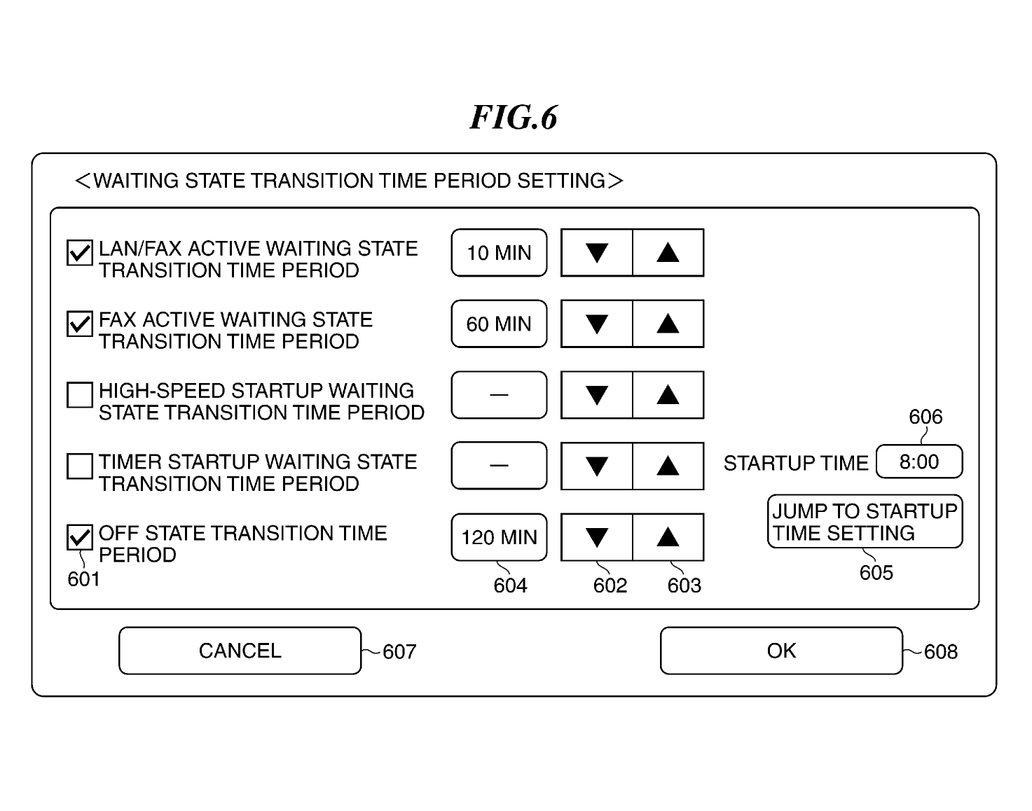

FIG. 6 shows a setting screen for making a setting for performing apparatus operation state transition according to the time period elapsed after completion of the operating state of the image processing apparatus 1.

On the setting screen of FIG. 6, there are displayed five check boxes 501 respectively corresponding to a “LAN/FAX active waiting state transition time period” option, a “FAX active waiting state transition time period” option, a “high-speed startup waiting state transition time period” option, a “timer startup waiting state transition time period” option, and an “off state transition time period.” By selectively touching one or more of the check boxes 601 on the setting screen, waiting state transition time periods can each be switched between valid and invalid. For each of the transition time periods that are made valid, a time period up to transition to the corresponding operation state can be input by using downward and upward buttons 602, 603, and the input content is displayed in a corresponding one of areas 604. When a “jump to startup time setting” button 605 is touched after the “timer startup waiting state time period” check box 601 is checked, the startup time setting screen of FIG. 4 is displayed and a startup time set on that screen is displayed in a startup time display field 606. When an OK button 608 is touched after all required contents have been input, input contents are set. When a cancel button 607 is touched, input contents are canceled.

The power controller 11, CPU 12, ROM 13, flash memory 14, DRAM 15, network controller 16, FAX controller 17, and soft switch 19 are an example of plural apparatuses that operate when supplied with power and that constitute an electronic apparatus of this invention.

The power controller 11, DRAM 15, network controller 16, FAX controller 17, and soft switch 19 are an example of a part (which can be supplied with power from the secondary battery) of the plural apparatuses of this invention.

The FETs 21 to 30 are an example of a switching unit of this invention that is capable of switching, on a per apparatus basis, either DC power output from a conversion unit (corresponding to the AC power unit 5) or power from the secondary battery is to be supplied to each of the part of the plural apparatuses.

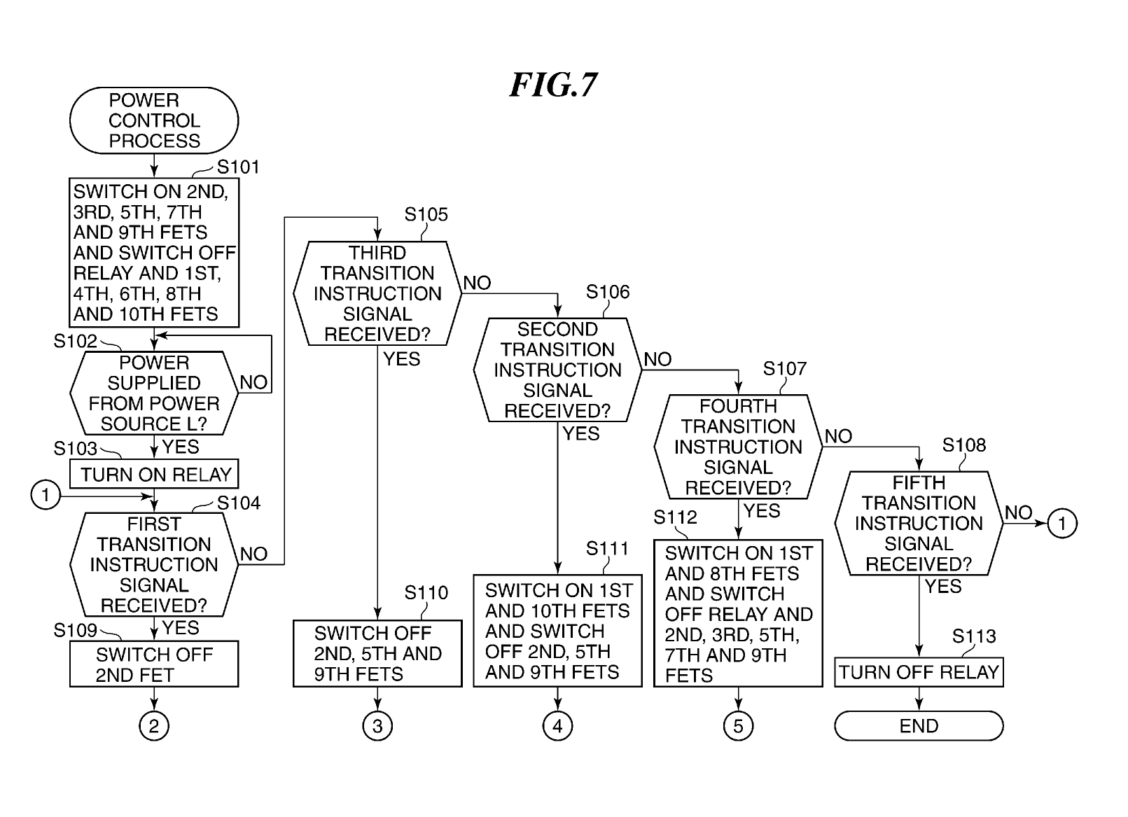

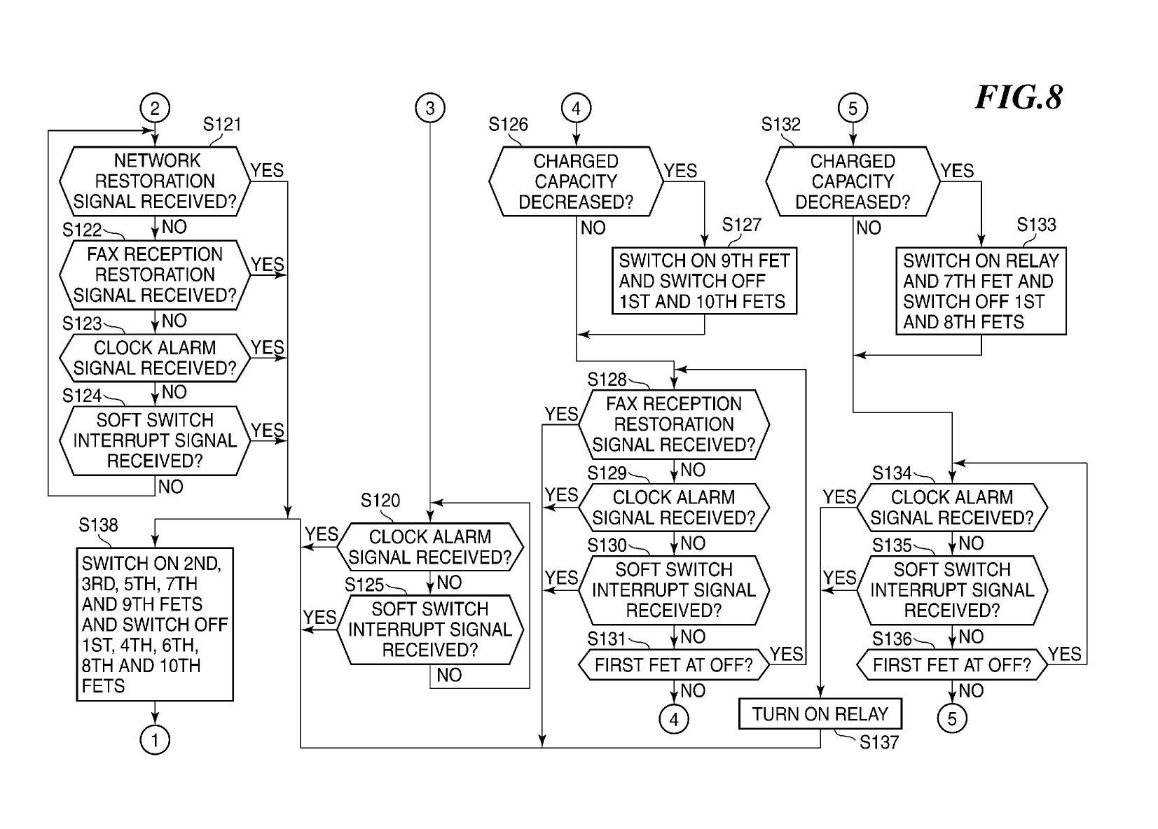

FIGS. 7 and 8 show in flowchart the procedures of a power control process executed by the power controller 11.

In the power control process, the power controller 11 outputs control signals S1 to S11 to the FETs 22 to 30, thereby switching on the second, third, fifth, seventh and ninth FETs 22, 23, 25, 27 and 29, and switching off the relay 4 and the first, fourth, sixth, eighth and tenth FETs 21, 24, 26, 28 and 30 (step S101). When the main power switch 3 is switched on and power is supplied from the power source L (if YES to step S102), the power controller 11 turns on the relay 4 (step S103).

Then, the power controller 11 determines whether or not the first transition instruction signal S21 that instructs transition to the LAN/FAX active waiting state (first waiting state) has been received from the CPU 12 (step S104). If determined in step S104 that the first transition instruction signal S21 has not been received (if NO to step S104), the power controller 11 determines whether or not the third transition instruction signal S23 that instructs transition to the high-speed startup waiting state (third waiting state) has been received (step S105).

If determined in step S105 that the third transition instruction signal S23 has not been received (if NO to step S105), the power controller 11 determines whether or not the second transition instruction signal S22 that instructs transition to the FAX active waiting state (second waiting state) has been received (step S106). If determined in step S106 that the second transition instruction signal S22 has not been received (if NO to step S106), the power controller 11 determines whether or not the fourth transition instruction signal S24 that instructs transition to the timer startup waiting state (fourth waiting state) has been received (step S107).

If determined in step S107 that fourth transition instruction signal S24 has not been received (if NO to step S107), the power controller 11 determines whether or not the fifth transition instruction signal S25 that instructs transition to the off state has been received (step S108). If determined in step S108 that fifth transition instruction signal S25 has not been received (if NO to step S108), the flow returns to step S104. It should be noted that the order of execution of steps S104 to S108 is not limited to the above-described order.

If determined in step S104 that the first transition instruction signal S21 has been received (if YES to step S104), the power controller 11 switches off the second FET 22 (step S109). As a result, the power source B is turned off, thereby disconnecting the power supply from the power source B to the CPU 12, ROM 13, flash memory 14, a part of the network controller 16 other than a part for detecting packets directed to the image processing apparatus 1, and a part of the FAX controller 17 other than a part for detecting an incoming FAX, thus reducing the power consumption.

Next, the power controller 11 determines whether or not a network restoration signal S32, which is output when a packet directed to the image processing apparatus 1 is detected by the network controller 16, has been received (step S121). If determined in step S121 that the network restoration signal S32 has not been received (if NO to step S121), the power controller 11 determines whether or not a FAX reception restoration signal S33, which is output when FAX reception is detected by the FAX controller 17, has been received (step S122).

If determined in step S122 that the FAX reception restoration signal S33 has not been received (if NO to step S122), the power controller 11 determines whether or not a clock alarm signal S34, which is output when the time set in advance in the clock IC 18 is reached, has been received (step S123).

If determined in step S123 that the clock alarm signal S34 has not been received (if NO to step S123), the power controller 11 determines whether or not a soft switch interrupt signal S31, which is output when the soft switch 19 is pressed, has been received (step S124). If determined in step S124 that the soft switch interrupt signal S31 has not been received (if NO to step S124), the flow returns to step S121.

If determined in any of steps S121 to S124 that the network restoration signal S32, FAX reception restoration signal S33, clock alarm signal S34, or soft switch interrupt signal S31 has been received (If YES to any of steps S121 to S124), the power controller 11 switches on the second, third, fifth, seventh and ninth FETs 22, 23, 25, 27 and 29, and switches off the first, fourth, sixth, eighth and tenth FETs 21, 24, 26, 28 and 30 (step S138), whereupon the flow returns to S104. It should be noted that the order of execution of steps S121 to S124 is not limited to the above-described order.

If determined in step S105 that the third transition instruction signal S23 has been received (if YES to step S105), the power controller 11 switches off the second, fifth and ninth FETs 22, 25 and 29 (step S110). As a result, the power sources B, N and F are turned off, thereby disconnecting the power supply to the CPU 12, ROM 13, flash memory 14, network controller 16, and FAX controller 17, thus further reducing the power consumption.

Next, the power controller 11 determines whether or not a clock alarm signal S34 has been received from the clock IC 18 (step S120). If determined in step S120 that the clock alarm signal S34 has not been received (if NO to step S120), the power controller 11 determines whether or not the soft switch interrupt signal S31 has been received (step S125). If the soft switch interrupt signal S31 has not been received (if NO to step S125), the flow returns to step S120. If determined in step S120 or S125 that the clock alarm signal S34 or the soft switch interrupt signal S31 has been received (if YES to step S120 or S125), the flow proceeds to step S138.

If determined in step S106 that the second transition instruction signal S22 has been received (if YES to step S106), the power controller 11 switches on the first and tenth FETs 21, 30 and switches off the second, fifth and ninth FETs 22, 25 and 29 (step S111). As a result, the source of power supply to the power source F is switched from the AC power unit 5 to the secondary battery 7. Further, the power sources B, N are made off, thereby disconnecting the power supply to the CPU 12, ROM 13, flash memory 14, and network controller 16 and to a part of the FAX controller 17 other than a part for detecting an incoming FAX, thus reducing the power consumption.

Next, the power controller 11 monitors the output voltage of the secondary battery 7 and determines whether or not a charged capacity of the secondary battery 7 has decreased below a predetermined value (step S126). If determined in step S126 that the charged capacity has not decreased below the predetermined value (if NO to step S126), the flow proceeds to step S128. If the charged capacity has decreased below the predetermined value (if YES to step S126), the power controller 11 switches on the ninth FET 29 and switches off the first and tenth FETs 21, 30 (step S127). As a result, the source of power supply to the power source F is switched from the secondary battery 7 to the AC power unit 5, whereupon the flow proceeds to step S128.

In step S128, the power controller 11 determines whether or not the FAX reception restoration signal S33 has been received from the FAX controller 17. If determined in step S128 that the FAX reception restoration signal S33 has not been received (if NO to step S128), the power controller 11 determines whether or not the clock alarm signal S34 has been received from the clock IC 18 (step S129).

If determined in step S129 that the clock alarm signal S34 has not been received (if NO to step S129), the power controller 11 determines whether or not the soft switch interrupt signal S31 has been received (step S130).

If determined in any of steps S128 to S130 that the FAX reception restoration signal S33 or the clock alarm signal S34 or the soft switch interrupt signal S31 has been received (if YES to any of steps S128 to S130), the flow proceeds to step S138. It should be noted that the order of execution of steps S128 to S130 is not limited to the above-described order.

If determined in step S130 that the soft switch interrupt signal S31 has not been received (if NO to step S130), the power controller 11 determines whether or not the first FET 21 is off (step S131). If the FET 21 is off (if YES to step S131), the flow proceeds to step S128. If the FET 21 is not off (if NO to step S131), the flow proceeds to step S126.

If determined in step S107 that the fourth transition instruction signal S24 has been received (if NO to step S107), the power controller 11 switches on the first and eighth FETs 21, 28, and switches off the relay 4 and the second, third, fifth, seventh and ninth FETs 22, 23, 25, 27 and 29 (step S112). As a result, the source of power supply to the power source L is switched from the AC power unit 5 to the secondary battery 7, all the power sources except for the power source L are turned off, and the power supply to respective parts other than the power controller 11 is disconnected (while supplying power to the clock IC 18 from the primary battery 20), thereby reducing the power consumption. In particular, since the relay 4 is turned off, the commercially available power is not consumed.

Next, the power controller 11 monitors the output voltage of the secondary battery and determines whether or not the charged capacity of the secondary battery 7 has decreased below a predetermined value (step S132). If it is determined in step S132 that the charge capacity has not decreased below the predetermined value (if NO to step S132), the flow proceeds to step S134. If the charged capacity has decreased below the predetermined value (if YES to step S132), the relay 4 and the seventh FET 27 are switched on, whereas the first and eighth FETs 21, 28 are switched off (step S133). As a result, the source of power supply to the power source L is switched from the secondary battery 7 to the AC power unit 5, whereupon the flow proceeds to step S134.

In step S134, the power controller 11 determines whether or not the clock alarm signal S34 has been received from the clock IC 18.

If determined in step S134 that the clock alarm signal S34 has not been received (if NO to step S134), the power controller 11 determines whether or not the soft switch interrupt signal S31 has been received (step S135). If determined in step S135 that the soft switch interrupt signal S31 has not been received (if NO to step S135), the power controller 11 determines whether or not the first FET 21 is off (step S136).

If determined in step S134 or S135 that the clock alarm signal S34 or the soft switch interrupt signal S31 has been received (if YES to step S134 or S135), the power controller 11 turns on the relay 4 (step S137) and proceeds to step S138. It should be noted that the order of execution of steps S134, S135 is not limited to the above-described order.

If determined in step S136 that the FET 21 is off (if YES to step S136), the flow proceeds to step S134. If the FET 21 is not off (if NO to step S136), the flow proceeds to step S132.

If determined in step S108 that the fifth transition instruction signal S25 has not been received (if NO to step S108), the flow proceeds to step S104. If the signal S25 has been received (if YES to step S108), the power controller 11 turns off the relay 4 (step S113) and completes the power control process. As a result, the image processing apparatus 1 completely stops operating.

In the power control process of FIGS. 7 and 8, if conversion efficiency of the AC power unit 5 (attained when the required power for all the apparatuses to be operated, among a part of the plural apparatuses that constitute the image processing apparatus 1, is supplied from the AC power unit 5) is higher than power use efficiency attained when the required power is supplied from the secondary battery 7, the power controller 11 controls the FET 21 to 30 such that the DC power output from the AC power unit 5 is supplied to the apparatuses to be operated. On the other hand, if the power use efficiency is higher than the conversion efficiency, the power controller 11 controls the FETs 21 to 30 such that the power is supplied from the secondary battery 7 to the apparatuses to be operated. It is therefore possible to reduce the power consumption in the image processing apparatus 1, which is an example electronic apparatus in which an AC power source and a secondary battery are used in combination.

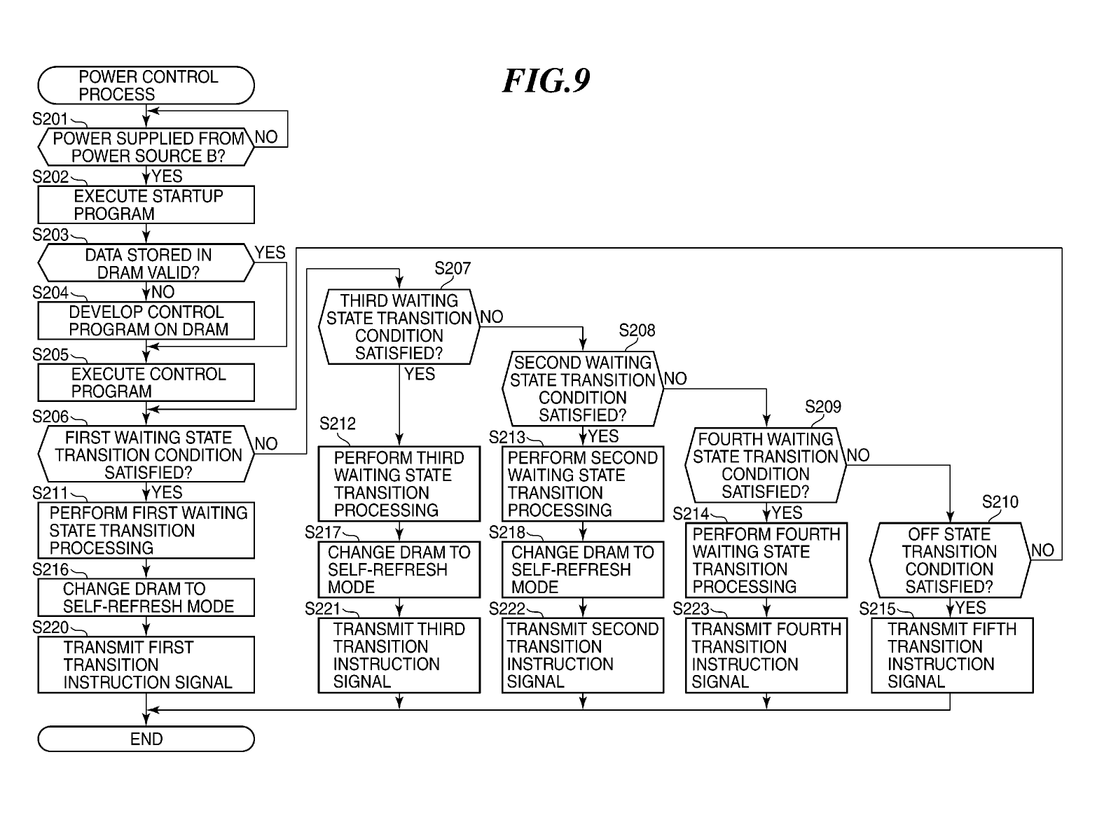

FIG. 9 shows in flowchart the procedures of a power control process executed by the CPU 12.

In the power control process of FIG. 9, when the power is supplied from the power source B to the CPU 12 (if YES to step S201), the CPU 12 executes the startup program in the ROM 13 on boot (step S202). Next, the CPU 12 refers to one bit data held in e.g. a flip-flop (not shown) and determines whether or not data stored in the DRAM 15 is valid (step S203). The one bit data assumes a value of “1” or “0”. For example, the value “1” represents that data stored in the DRAM 15 is valid, and the value “0” represents that the data stored in the DRAM 15 is invalid.

If determined in step S203 that the data stored in the DRAM 15 is valid (if YES to step S203), the flow proceeds to step S205. If the data stored in the DRAM 15 is invalid (if NO to step S203), the CPU 12 reads the control program from the flash memory 14 and develops the program on the DRAM 15 (step S204), whereupon the flow proceeds to step S205.

In step S205, the CPU 12 executes the control program developed on the DRAM 15, and causes the charging circuit 6 to charge the secondary battery 7, if the charged capacity of the secondary battery 7 is not sufficient. It should be noted that since step S204 is skipped when the data stored in the DRAM 15 is determined to be valid instep S203, the startup time period can be shortened.

Next, the CPU 12 determines whether or not the LAN/FAX active waiting state transition condition (first waiting state transition condition) is satisfied (step S206). The LAN/FAX active waiting state transition condition is satisfied in any of the following four cases where:

(1) The soft switch 19 is pressed for less than 2 seconds after the “LAN/FAX active waiting state” option has been selected on the setting screen of FIG. 3,

(2) The “LAN/FAX active waiting state” button 801 is touched on the setting screen of FIG. 5 displayed in response to the press of the soft switch 19 for less than 2 seconds after the “case-by-case selection” option has been selected in the setting on the setting screen of FIG. 3 for the case of the soft switch being pressed for less than 2 seconds,

(3) The “LAN/FAX active waiting state” button 801 is touched on the setting screen of FIG. 5 displayed in response to the press of the soft switch 19 for 2 seconds or longer after the “case-by-case selection” option has been selected in the setting on the setting screen of FIG. 3 for the case of the soft switch being pressed for 2 seconds or longer, and

(4) The set transition time period has elapsed from completion of the operating state of the image processing apparatus 1 after the “LAN/FAX active waiting state transition time period” has been set on the setting screen of FIG. 6.

It should be noted that the high-speed startup transition condition, FAX active waiting state transition condition, and timer startup waiting state transition condition are each satisfied in cases similar to the above-described cases (1) to (4), and therefore, a description of these conditions will be omitted.

The off state transition condition is satisfied in any of the following four cases where:

(i) The soft switch 19 is pressed for 2 seconds or longer after the “off state” option has been selected on the setting screen of FIG. 3,

(ii) The “off state” button 805 is touched on the setting screen of FIG. 5 displayed in response to the press of the soft switch 19 for less than 2 seconds after the “case-by-case selection” option has been selected in the setting on the setting screen of FIG. 3 for the case of the soft switch being pressed for less than 2 seconds,

(iii) The “off state” button 805 is touched on the setting screen of FIG. 5 displayed in response to the press of the soft switch 19 for 2 seconds or longer after the “case-by-case selection” option has been selected in the setting on the setting screen of FIG. 3 for the case of the soft switch being pressed for 2 seconds or longer, and

(iv) The set transition time period has elapsed from completion of operating state of the image processing apparatus 1 after the “off state transition time period” has been set on the setting screen of FIG. 6.

If determined in step S206 that the LAN/FAX active waiting state transition condition (first waiting state transition condition) is satisfied (if YES to step S206), the CPU 12 performs processing for transition to the LAN/FAX active waiting state (first waiting state transition processing) (step S211). For example, the CPU 12 performs processing to cause the network controller 16, when detecting a packet directed to the image processing apparatus 1, to output the network restoration signal S32, and performs processing to cause the FAX controller 17, when detecting an incoming FAX, to output the FAX reception restoration signal S33. If the transition to other waiting state or to the off state has been made valid, the CPU 12 performs processing to set to the clock IC 18 a time period up to a set transition time or performs CPU shutdown processing such as saving internal registers of the CPU 12.

Next, the CPU 12 changes the DRAM 15 to the self-refresh mode (step S216), transmits the first transition instruction signal S21 that instructs the transition to the LAN/FAX active waiting state (step S220), and completes the present process. As a result, the power supply to the CPU 12 is disconnected.

If determined in step S206 that the LAN/FAX active waiting state transition condition is not satisfied (if NO to step S206), the CPU 12 determines whether or not the high-speed startup waiting state transition condition (third waiting state transition condition) is satisfied (step S207).

If determined in step S207 that the high-speed startup waiting state transition condition is satisfied (if YES to step S207), the CPU 12 performs processing for transition to the high-speed startup waiting state (third waiting state transition processing) (step S212). For example, if the transition to other waiting state or to the off state has been made valid, the CPU 12 performs processing to set a time period up to a set transition time or performs CPU shutdown processing.

Next, the CPU 12 changes the DRAM 15 to the self-refresh mode (step S217), transmits the third transition instruction signal S23 that instructs the transition to the high-speed startup waiting state (step S221), and completes the present process. As a result, the power supply to the CPU 12 is disconnected.

If determined in step S207 that the high-speed startup waiting state transition condition is not satisfied (if NO to step S207), the CPU 12 determines whether or not the FAX active waiting state transition condition (second waiting state transition condition) is satisfied (step S208).

If determined in step S208 that the FAX active waiting state transition condition is satisfied (if YES to step S208), the CPU 12 performs processing for transition to the FAX active waiting state (second waiting state transition processing) (step S213). For example, the CPU 12 performs processing to cause the FAX controller 17, when detecting an incoming FAX, to output the FAX reception restoration signal S33. If the transition to other waiting state or to the off state has been made valid, the CPU 12 performs processing to set a time period up to a set transition time or performs CPU shutdown processing.

Next, the CPU 12 changes the DRAM 15 to the self-refresh mode (step S218), and transmits the second transition instruction signal S22 that instructs transition to the FAX active waiting state (step S222), whereupon the present process is completed. As a result, the power supply to the CPU 12 is disconnected.

If determined in step S208 that the FAX active waiting state transition condition is not satisfied (if NO to step S208), the CPU 12 determines whether or not the timer startup waiting state transition condition (fourth waiting state transition condition) is satisfied (step S209).

If determined in step S209 that the timer startup waiting state transition condition is satisfied (if YES to step S209), the CPU 12 performs processing for transition to the timer startup waiting state (fourth waiting state transition processing) (step S214). For example, if the transition to other waiting state or to the off state has been made valid, the CPU 12 performs processing to set a time period up to a set transition time or performs CPU shutdown processing. Next, the CPU 12 transmits the fourth transition instruction signal S24 that instructs the transition to the timer startup waiting state (step S223), and completes the present process. As a result, the power supply to the CPU 12 is disconnected.

If determined in step S209 that the timer startup waiting state transition condition is not satisfied (if NO to step S209), the CPU 12 determines whether or not the off state transition condition is satisfied (step S210).

If determined in step S210 that the off state transition condition is satisfied (if YES to step S210), the CPU 12 transmits the fifth transition instruction signal S25 that instructs the transition to the off state (step S215), and completes the present process. As a result, the power supply to the CPU 12 is disconnected. On the other hand, if the off state transition condition is not satisfied (if NO to step S210), the flow returns to step S206. It should be noted that the order of execution of steps S206 to S210 is not limited to the above-described order.

With regard to the power control process of FIGS. 7 to 9, power consumption on the DC secondary side of the AC power unit 5 is 0.65 W in the LAN/FAX active waiting state and AC/DC conversion efficiency of the AC power unit 5 at that time is 72%. This AC/DC conversion efficiency is higher than power use efficiency of the secondary battery 7, which is e.g. 64%. Accordingly, total power consumption including power consumption at the time of charging can be reduced by supplying power from the AC power unit 5 rather than by supplying power from the secondary battery 7.

Power consumption on the DC secondary side of the AC power unit 5 is 0.25 W in the FAX active waiting state and AC/DC conversion efficiency of the AC power unit 5 at that time is 50%. It is therefore advantageous to supply power from the secondary battery 7 rather than to supply power from the AC power unit 5. However, a large-capacity, high-priced secondary battery is required to supply all the power from the secondary battery 7. By supplying power from the secondary battery 7 to only that part of the FAX controller 17 which detects an incoming FAX and whose power consumption is 0.05 W, it becomes possible to effectively reduce the power consumption.

Power consumption on the DC secondary side of the AC power unit 5 is 0.2 W in the high-speed startup waiting state and AC/DC conversion efficiency of the AC power unit 5 at that time is 44%. It is therefore advantageous to supply power from the secondary battery 7 rather than to supply power from the AC power unit 5. However, power consumptions of the power controller 11 and the DRAM 15 which are to be supplied with power are 0.02 W and 0.18 W, respectively, and a large-capacity, high-priced secondary battery is required to cover 0.18 W power consumption of the DRAM 15. When the power is supplied from the secondary battery 7 only to the power controller 11 whose power consumption is 0.02 W, there occurs a reduction in AC/DC conversion efficiency of the AC power unit 5. Accordingly, it is preferable to supply the power from the AC power unit 5 rather than to supply the power from the secondary battery 7.

Power consumption on the DC secondary side of the AC power unit 5 is about 0.02 W in the timer startup waiting state and AC/DC conversion efficiency of the AC power unit 5 at that time is 8%. Thus, power consumption can be reduced by supplying all the power from the secondary battery 7, with the relay 4 turned off to disconnect the supply of commercially available AC power to the AC power unit 5.

As described above, in the image processing apparatus 1 having a plurality of waiting states in each of which a communication function can be stopped, the secondary battery 7 is used for power supply when the power use efficiency of the battery 7 is higher than the AC/DC conversion efficiency of the AC power unit 5 in the waiting state concerned. As a result, the power consumption can be reduced, without lowering the user-friendliness of the image processing apparatus 1. In particular, in the timer startup waiting state where the AC/DC conversion efficiency of the AC power unit 5 becomes low, the power consumption can largely be reduced by using the power of the secondary battery 7 and by turning off the AC power unit 5.

In the above-described embodiment, an electrically rewritable nonvolatile memory such as a flash memory can be used instead of the ROM 13. The startup program of the CPU 12 can be stored in the flash memory 14 instead of in the ROM 13. The control program of the image processing apparatus 1 can be stored in a storage device (such as a hard disk) other than a nonvolatile memory.

In the above-described embodiment, a case has been described in which the condition for transition to each waiting state or to the off state is satisfied when a predetermined time period has elapsed from the soft switch 19 being pressed or from completion of the operation state of the image processing apparatus 1. However, the transition to each waiting state or to the off state can be made when a time set in advance is reached or when a transition instruction is received from an information processing apparatus (not shown) through a network. Although the startup time setting screen of FIG. 4 is configured to set one type of startup time, the startup time setting screen can be configured to set startup times for respective days of the week, for example.

The image processing apparatus 1 of the above-described embodiment is provided with the FAX controller 17 that controls facsimile communication. However, it is not inevitably necessary to provide the FAX controller. In that case, the image processing apparatus 1 assumes a LAN active waiting state instead of the LAN/FAX active waiting state, and does not assume a FAX active waiting state.

According to the above-described embodiment, the secondary battery 7 is not used for power supply in the LAN/FAX active waiting state and in the high-speed startup waiting state, but used for power supply to the FAX controller 17 in the FAX active waiting state and used for power supply to the power controller 11 in the timer startup waiting state. However, this is not limitative.

In the above-described embodiment, there are shown example values of AC/DC conversion efficiency of the AC power unit 5, power use efficiency of the secondary battery 7, and amounts of power consumption of the power controller 11, DRAM 15, network controller 16, and FAX controller 17. It is preferable to decide power supply objects which are to be supplied with power from the secondary battery 7 in each waiting state according to values of efficiencies and amounts of power consumption. In a case, for example, that an amount of power consumption of the network controller 16 is small, the secondary battery 7 can be used for power supply in the LAN/FAX active waiting state.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2011-275565, filed Dec. 16, 2011, which is hereby incorporated by reference herein in its entirety.

What is claimed is:

1. An electronic apparatus constituted by plural apparatuses that operate when supplied with power, comprising:
a conversion unit configured to convert AC power supplied from an AC power source into DC power for output;
a secondary battery configured to be charged with the DC power output from said conversion unit and configured to be capable of supplying power to a part of the plural apparatuses;
a switching unit configured to be capable of switchingly supplying to the part of the plural apparatuses, on a per apparatus basis, either the DC power output from said conversion unit or power from said secondary battery; and
a control unit configured, in a case where conversion efficiency of said conversion unit attained when required power for all apparatuses to be operated, among the part of the plural apparatuses, is supplied from said conversion unit is higher than power use efficiency attained when the required power is supplied from said secondary battery, to control said switching unit such that the DC power output from said conversion unit is supplied to the apparatuses to be operated, and configured, in a case where the power use efficiency is higher than the conversion efficiency, to control said switching unit such that power is supplied from said secondary battery to the apparatuses to be operated.

2. The electronic apparatus according to claim 1, wherein in a case where power is being supplied from said secondary battery to the apparatuses to be operated, when a charged capacity of said secondary battery has decreased below a predetermined value, said control unit controls said switching unit such that the DC power output from said conversion unit is supplied to the apparatuses to be operated.

3. A control method for an electronic apparatus constituted by plural apparatuses that operate when supplied with power and including a conversion unit configured to convert AC power supplied from an AC power source into DC power for output and a secondary battery configured to be charged with the DC power output from the conversion unit and configured to be capable of supplying power to a part of the plural apparatuses, comprising:
a switching step of being capable of switchingly supplying to the part of the plural apparatuses, on a per apparatus basis, either the DC power output from the conversion unit or power from the secondary battery; and
a control step, in a case where conversion efficiency of the conversion unit attained when required power for all apparatuses to be operated, among the part of the plural apparatuses, is supplied from the conversion unit is higher than power use efficiency attained when the required power is supplied from the secondary battery, of controlling said switching step such that the DC power output from the conversion unit is supplied to the apparatuses to be operated, and in a case where the power use efficiency is higher than the conversion efficiency, of controlling said switching step such that power is supplied from the secondary battery to the apparatuses to be operated.

4. A non-transitory computer-readable storage medium storing a program for causing a computer to execute the control method as set forth in claim 3.
